(19) United States
(12) Patent Application Publication
(10) Pub. No.: US 2026/0320526 A1
(43) Pub. Date: Oct. 15, 2026

(54) END USER WORKFLOW AUTOMATION FRAMEWORK

(71) Applicant: ServiceNow, Inc., Santa Clara, CA (US)

(72) Inventors: Alberto Alvarado Jimenez, San Diego, CA (US); Reema Shah, San Diego, CA (US); Jacob Samuel Burman, Carlsbad, CA (US); Milap Dhirenkumar Shah, Ahmedabad (IN); Michel Abou Samah, San Diego, CA (US); Benjamin Peter, Prior Lake, MN (US); Brian Paul Bimschleger, Highland Park, IL (US)

(21) Appl. No.: 19/175,766

(22) Filed: Apr. 10, 2025

(51) Int. Cl. G06Q 10/0633

(52) U.S. Cl. CPC G06Q 10/0633

(57) ABSTRACT

Aspects of the subject technology relate to systems, methods, and computer-readable media for providing an end user workflow automation framework that allows developers to configure experiences that enable end users to automate their work in a production environment. An example method can include determining a set of flow components based on an operator input in a workflow automation platform associated with a plurality of applications. The example method can include generating a workflow automation tool using the set of flow components, validating the workflow automation tool based on an administrator input in the workflow automation platform, and providing the workflow automation tool in a production environment. The workflow automation tool may enable an end user of at least one of the plurality of applications to build a flow within the production environment.

### BACKGROUND

### 1. Technical Field

The present disclosure generally relates to workflow automation, and more specifically to providing an end user workflow automation framework in a production environment.

### Introduction

Entities such as business enterprises and other organizations often utilize workflow automation platforms to autonomously manage the flow of tasks and data based on business rules, needs, and/or constraints. The workflow automation platforms can streamline processes, reduce manual work, and enhance operational efficiency. For example, a developer can access the workflow automation platforms to build a flow, which can include specific sequences or series of tasks, processes, and/or actions to accomplish respective goals. The process of automating flows can be difficult since a flow and characteristics of an accurate flow can vary depending on various factors.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure.

FIG. 1B is a block diagram illustrating an example network architecture that can be used to implement one or more aspects, components, devices, nodes, systems, instances, and/or portions of the example cloud computing architecture, according to some examples of the present disclosure.

FIG. 2 is a diagram illustrating an example system for providing an end user workflow automation framework, according to some examples of the present disclosure.

FIG. 3 illustrates a flowchart of an example system process for providing an end user workflow automation framework in a production environment for end users, according to some examples of the present disclosure.

FIG. 4 illustrates a flowchart of an example process of implementing an end user workflow automation engine, according to some examples of the present disclosure.

FIG. 5 is a diagram illustrating an example method of providing an end user workflow automation framework, according to some examples of the present disclosure.

FIGS. 6A and 6B are diagrams illustrating a user interface depicting a representation of an example end user input for generating a workflow based on a workflow automation tool, according to some examples of the present disclosure.

FIG. 7 is an example of a deep learning neural network that can be used to implement all or a portion of the systems and techniques described herein, according to some examples of the present disclosure.

FIG. 8 is a diagram illustrating an example architecture of an example transformer model, according to some examples of the present disclosure.

FIG. 9 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As discussed previously, entities such as business enterprises and other organizations often utilize workflow automation platforms to autonomously manage the flow of tasks and data based on business rules, needs, and/or constraints. The workflow automation platforms can streamline processes, reduce manual work, and enhance operational efficiency. For example, a developer can access the workflow automation platforms to build a flow, which can include specific sequences or series of tasks, processes, and/or actions to accomplish respective goals. The process of automating flows can be difficult since a flow and characteristics of an accurate flow can vary depending on various factors.

Due to the complexity of creating a flow, workflow automation tools are accessible by developers to create flows to automate enterprise-wide processes. For example, developers develop scripts, specify actions, run tests, and deploy the workflow to production to deliver to end-users. As follows, end users would have to rely on developers to automate their work, which can lead to long lead times. Also, end users are bound by predefined and inflexible workflows that are defined by developers. If goals or needs of end users are not clearly communicated or understood by developers, developers may lack the necessary context, which can lead to an inadequate or incomplete flow.

The disclosed technology addresses the foregoing by providing an end user workflow automation framework that allows developers/operators to configure experiences (e.g., available triggers and actions of a workflow) that enable end users to automate their work in a production environment. For example, the disclosed technology can generate a workflow tool and/or template based on input from a developer (also referred to as an operator), which then can be validated by an administrator. The workflow tool and/or template can be surfaced into a production environment where end users can directly build a workflow to automate their work. As follows, an accuracy and/or quality of a flow can be improved by providing an end user with direct access to build a workflow in production in a streamlined manner.

Also, the disclosed technology can provide solutions for highly configurable workflow experiences, further improving the scalability of a workflow automation system. The disclosed technology provides a workflow automation experience (e.g., a workflow automation tool and/or template), which can be reusable across the Software as a Service (SaaS) platform such that multiple business units can utilize and embed the experience within their applications.

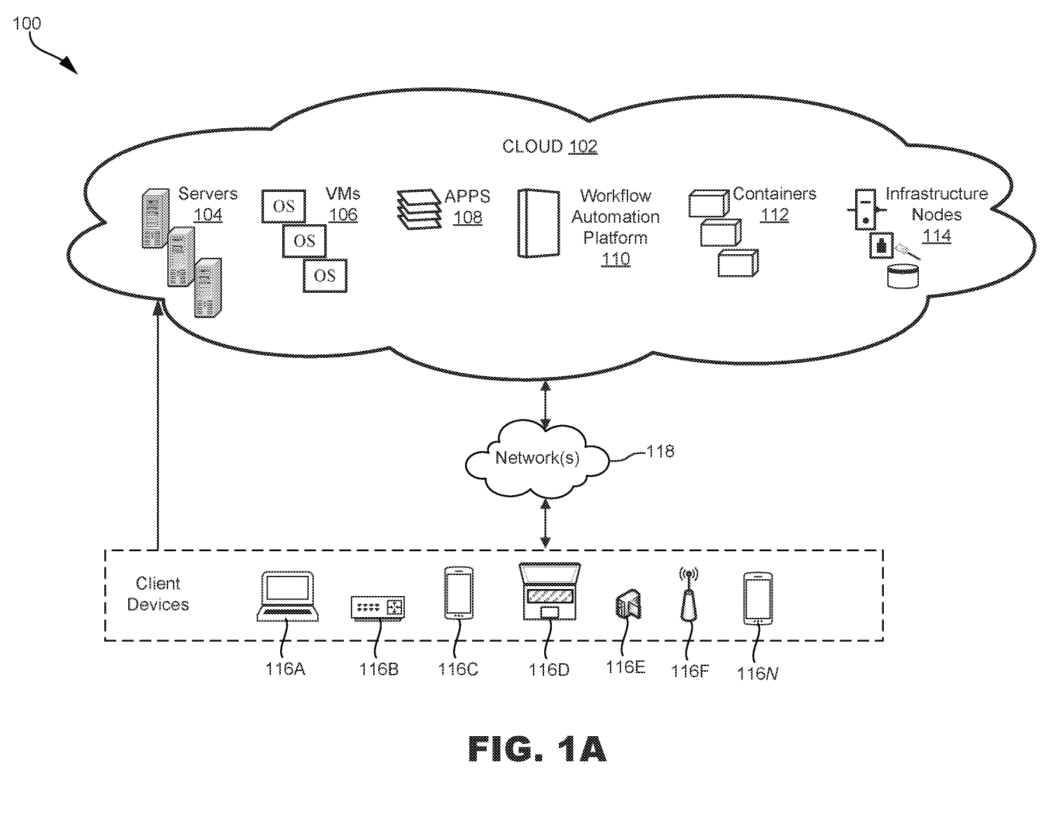

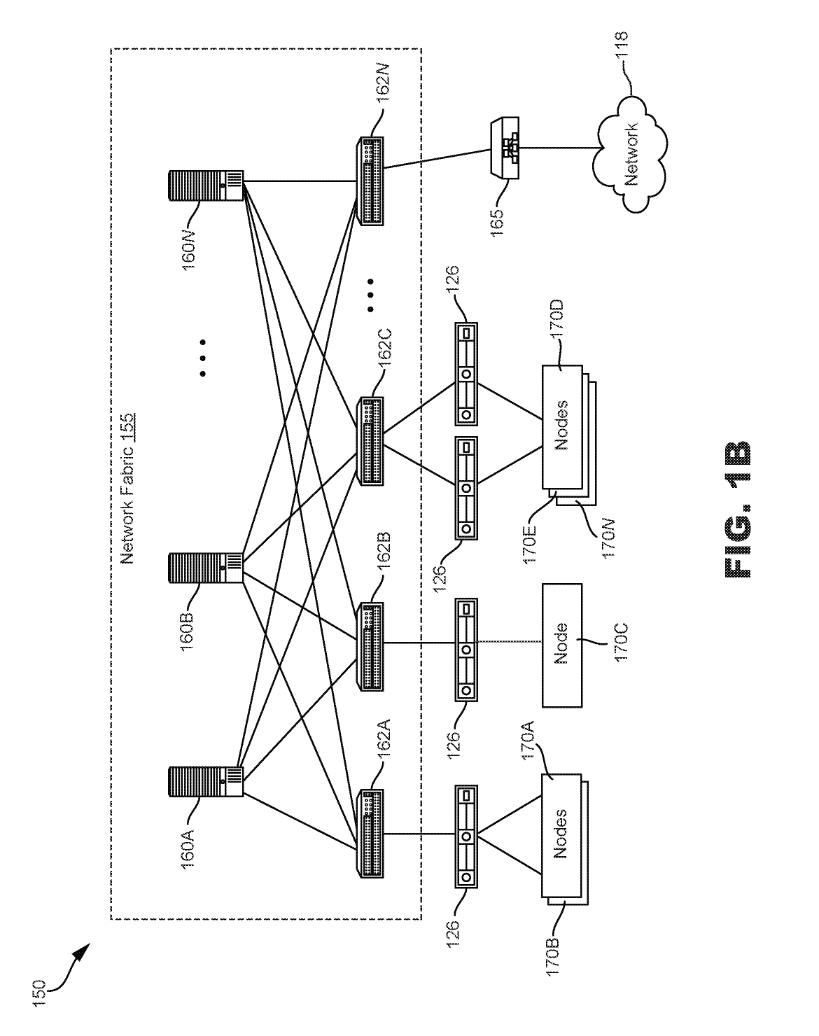

FIG. 1A illustrates a diagram of an example cloud computing environment 100 that can be used to implement a workflow automation system, according to some examples of the present disclosure. The cloud computing environment 100 can include and/or represent a cloud 102. The cloud 102 can include one or more private clouds, public clouds, and/or hybrid clouds. Moreover, the cloud 102 can include cloud elements 104-114. The cloud elements 104-114 can include or represent, for example, servers 104, virtual machines (VMs) 106, applications or services 108, workflow automation platform 110, software containers 112, and/or infrastructure nodes 114. The infrastructure nodes 114 can include various types of nodes, such as compute nodes, storage nodes, network nodes, management systems, etc.

The cloud 102 can provide cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client devices 116A-N (collectively referred to as “client devices 116” hereinafter) can connect with the cloud 102 to obtain one or more specific services from the cloud 102. The client devices 116 can connect with the cloud 102 from any network of the client devices 116 such as a local area network (wired and/or wireless), a cellular network, and/or any other network, and using the network(s) 118 to transport communications between the cloud 102 and the client devices 116. For example, the client devices 116 can communicate with the cloud 102 and/or any of the elements 104-114 via a network(s) 118. The network(s) 118 can include one or more public networks (e.g., the Internet, a wide area network, etc.), one or more private networks (e.g., local area network(s), wireless local area network(s), private backbone network(s), etc.), and/or one or more hybrid networks (e.g., virtual private network(s), public and private cloud network(s), etc.).

The client devices 116 can include any device with networking capabilities, such as a laptop computer, a tablet computer, a server, a desktop computer, a smartphone, a network device (e.g., an access point, a router, a switch, etc.), a smart television, a smart car, a sensor system, a gaming console, a smart wearable device (e.g., smartwatch, etc.), an internet of things (IoT) device, a camera, a network printer, or any other computing device.

In some examples, the cloud 102 can implement workflow automation platform 110 associated with one or more entities. The client devices 116 can access the workflow automation platform 110 implemented and/or hosted in the cloud 102 to generate and/or access workflow templates, flows, and/or flow information, as further described herein. An example network architecture that can be used to implement a network or datacenter (or any portion thereof), such as the cloud 102, is shown in FIG. 1B and further described below. In some cases, one or more services, components, devices, nodes, systems, instances, and/or portions of the example network architecture 150 shown in FIG. 1B can be implemented by and/or in a cloud network or datacenter, such as the cloud 102.

FIG. 1B is a block diagram illustrating an example network architecture 150 that can be used to implement one or more portions of the example cloud computing environment 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run workloads/nodes. In some cases, a cloud node can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the node can host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, the cloud 102. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126, the network device 165, and/or the nodes 170A-N (collectively referred to as “nodes 170” hereinafter) with any portion of the network fabric 155 (e.g., including each other). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g., network 118, various network elements, the network device 165, the nodes 170, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. For example, the system servers 126 can implement any of the applications 108 and/or the workflow automation platform 110 hosted on the cloud 102. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170. In some examples, the nodes 170 can represent cloud instances. For example, in some cases, the nodes 170 can each represent a virtual server and/or environment (e.g., a VM, a software container, etc.) that uses compute, memory, storage, and/or networking resources on the cloud (e.g., network architecture 150) for respective workloads. For example, the nodes 170 can implement any of the applications 108 and/or workflow automation platform 110 hosted on the cloud 102. In some implementations, the nodes 170 can perform parallel computing using, for example, multithreading. Each of the nodes 170 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 can represent a node instance that includes, implements, hosts, and/or runs a software container(s), an application(s), and/or a data augmentation system(s). In some examples, a software container(s) associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, and/or the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

An enterprise network, a workflow automation system, and/or a workflow automation platform associated with an entity can be implemented through the cloud computing environment 100 shown in FIG. 1A and the network architecture 150 shown in FIG. 1B. For example, the user interfaces, data structures, and logic to implement the workflow automation platform 110 and perform flow template and/or flow generation as described herein can be implemented through the cloud computing environment 100 and/or the network architecture 150.

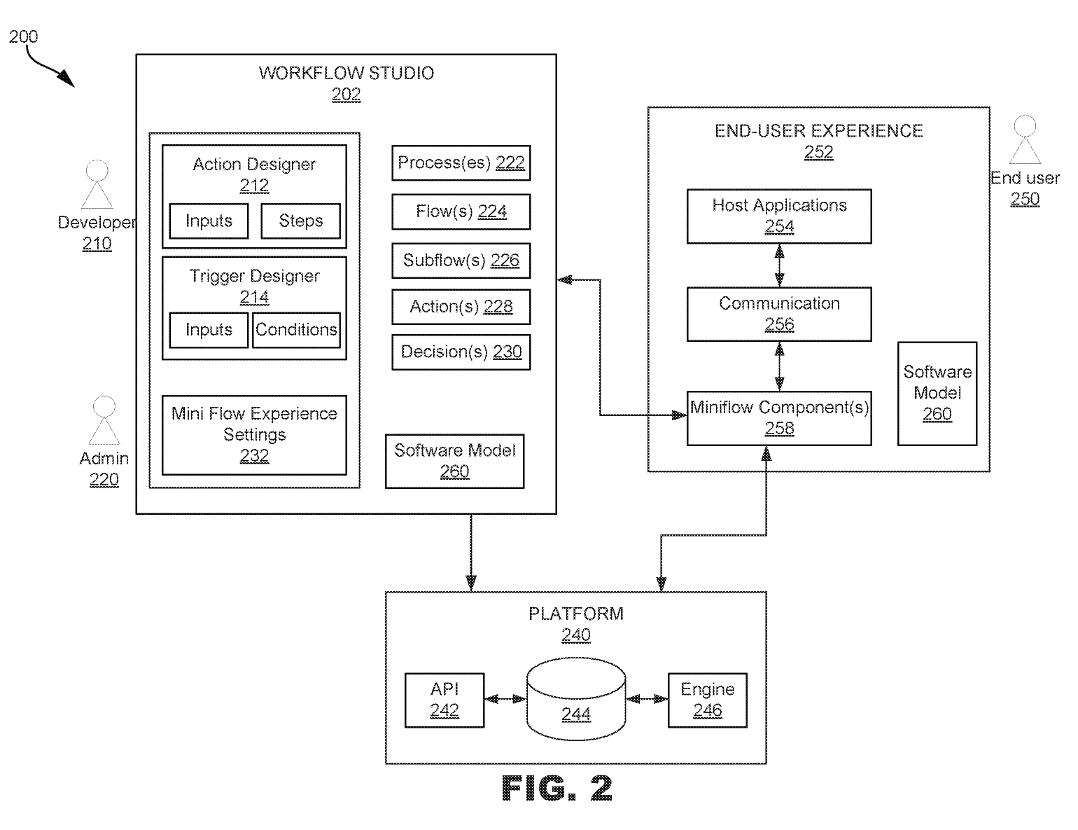

FIG. 2 is a diagram illustrating an example system 200 for providing an end user workflow automation framework, according to some examples of the present disclosure. The example system 200 provides a workflow automation framework that enables three roles (e.g., three personas including developer/operator 210, administrator (admin) 220, and end user 250) to define what can be automated and how it can be executed. In this example, a developer 210 and/or admin 220 can use a client device(s) 116 to build an end-user workflow automation tool (also referred to as miniflow experience, end-user experience, or end-user workflow automation experience) to a workflow automation platform 240, which can be accessed by end user 250 to generate a flow on the workflow automation platform 240 in a production environment to automate the end user’s work. The workflow automation platform 240 can represent one of the workflow automation platforms 110 in the cloud 102 shown in FIG. 1A.

In this example, workflow studio 202 may include a sub-production development studio where a developer 210 and/or admin 220 can build and configure flows or flow templates that can be executed on sub-production and pushed up to production for end user 250 to run. For example, workflow studio 202 can represent an application that developer 210 and/or admin 220 can access for various reusable components associated with workflows. Specifically, workflow studio 202 can provide an interface that developer 210 and/or admin 220 can use to build and design a miniflow experience for end user 250 to utilize and automate their work within a production environment.

In some examples, workflow studio 202 may receive input from developer 210, which describes actions and triggers available for end user 250. For example, developer 210 may determine, using an interface of workflow studio 202, end-user inputs and/or steps that may be available or accessible for end user 250 to utilize when creating a workflow. As follows, action designer 212 can, based on input from developer 210, define one or more end-user inputs that would determine a category of a workflow or any details associated with a workflow and determine a plurality of steps available for end user 250 to select from.

Further, developer 210 may determine, using an interface of workflow studio 202, end-user inputs and/or conditions that may be available or accessible for end user 250. For example, trigger designer 214 can, based on input from developer 210, define one or more end-user inputs and a plurality of conditions (e.g., triggers) for end user 250 to select when creating a workflow.

In some instances, workflow studio 202 may, based on input from admin 220, define and configure various miniflow experience settings 232 (e.g., accessibility, scope, a length of time for running the action, etc.). The admin 220 can, for example using an interface of workflow studio 202, configure and limit, if needed, who can do or what can be done in the production instance when creating a workflow. In some examples, admin 220 can configure access to triggers, actions, or templates based on existing or new roles the user has. Further, admin 220 can change the frequency and quantity of automations each user can activate at the same time. In some cases, admin 220 can configure execution rules or order of priority, for example, based on business needs. Also, workflow studio 202 can, based on input from admin 220, run tests with sample data, identify any potential bottlenecks, errors, or missing steps, and so on.

As shown, workflow studio 202 may include and store various components such as process(es) 222, flow(s) 224, subflow(s) 226, action(s) 228, decision(s) 230, and so on. The process(es) 222 includes a series of steps or a workflow designed to automate a task. The flow(s) 224 comprises a trigger(s) and a sequence of actions 228, and optionally includes a flow logic. The subflow(s) 226 includes a sequence of actions 228 to use in the flow. For example, subflow(s) 226 may automate a repeatable multi-step process that also produces an output needed by another process 222. The action(s) 228 automates a repeatable task or operation within a flow (e.g., flow(s) 224). The decision(s) 230 includes decision tables, which store sets of decision rules (e.g., if-then rules, etc.).

The platform 240 (similar to a workflow automation platform 110) is configured to manage workflow(s) of tasks and data. The platform 240 can include Application Programming Interface (API) 242 for integration and communication, database 244 that stores data structures, tables, etc. that may be associated with workflow(s) and/or workflow template(s), and engine 246 (e.g., flow engine) for processing the workflow(s).

In some examples, end-user experience 252 includes a production environment where end user 250 can build the automation on demand within the end user’s environment using an end-user workflow automation tool (e.g., miniflow experience), which is built/created by developer and/or admin 220. For example, platform 240 can be accessed to obtain miniflow component(s) 258 that may be needed to build a workflow. As previously described, miniflow component(s) 258 may include various reusable components across the platform 240 such as flows, subflows, actions, decisions, triggers, conditions, etc. As follows, end-user experience 252 enables end user 250 to automate end user’s work in production instance based on workflow templates created in workflow studio 202. For example, end user 250 who is responsible for problem management in Information Technology (IT) department has identified 100 similar cases and would like to automatically close 100 cases and notify everyone who submitted the problem with a common message. The end user 250 can use an end-user automation tool to automate the process without having to rely on developer 210 and/or admin 220 to create and test the automation and surface it to the production instance. As follows, end user 250 can automate processes in a simple and curated design environment and enhance the personal productivity at enterprise scale.

In some cases, different business units can utilize and embed miniflows (e.g., an end-user workflow automation tool) within their respective host applications 254. For example, the end-user workflow automation tool can be built based on different sets of credentials (e.g., IT Service Management (ITSM), Collaborative Work Management (CWM), Customer Service Management (CSM), Human Resources (HR), etc.). As follows, the same end-user workflow automation tool can be used to build a flow across various host applications 254 and business units at an enterprise scale.

Further, end-user experience 252 enables or facilitates communication between developer 210 and end user 250 via communication 256. For example, communication 256 may include an application or interface where developer 210 and end user 250 can share and exchange information to improve the efficiency of the end-user workflow automation tool and the productivity of the workflow automation. Using communication 256, end user 250 can provide user needs or expectations, inquire concerns or issues, requests for certain features, etc. and developer 210 can help end user 250 with how to use the workflow automation tool, address the end user’s needs, and so on.

In some examples, an artificial intelligence (AI) model such as a large language model (LLM) can be used to parse and process input(s) from developer 210, admin 220, and/or end user 250. For example, software model 260 implemented within workflow studio 202 and/or end-user experience 252 can receive a prompt in natural language from developer 210, admin 220, and/or end user 250 that describes workflow automation. The software model 260 can process and analyze the prompt to automatically generate output (e.g., miniflows, workflow templates, workflows, etc.). Also, software model 260 can be used for flow recommendation. For example, when end user 250 provides input or prompt regarding a sequence of actions, software model 260 can suggest what the next step could be, how the flow can be executed, and so on.

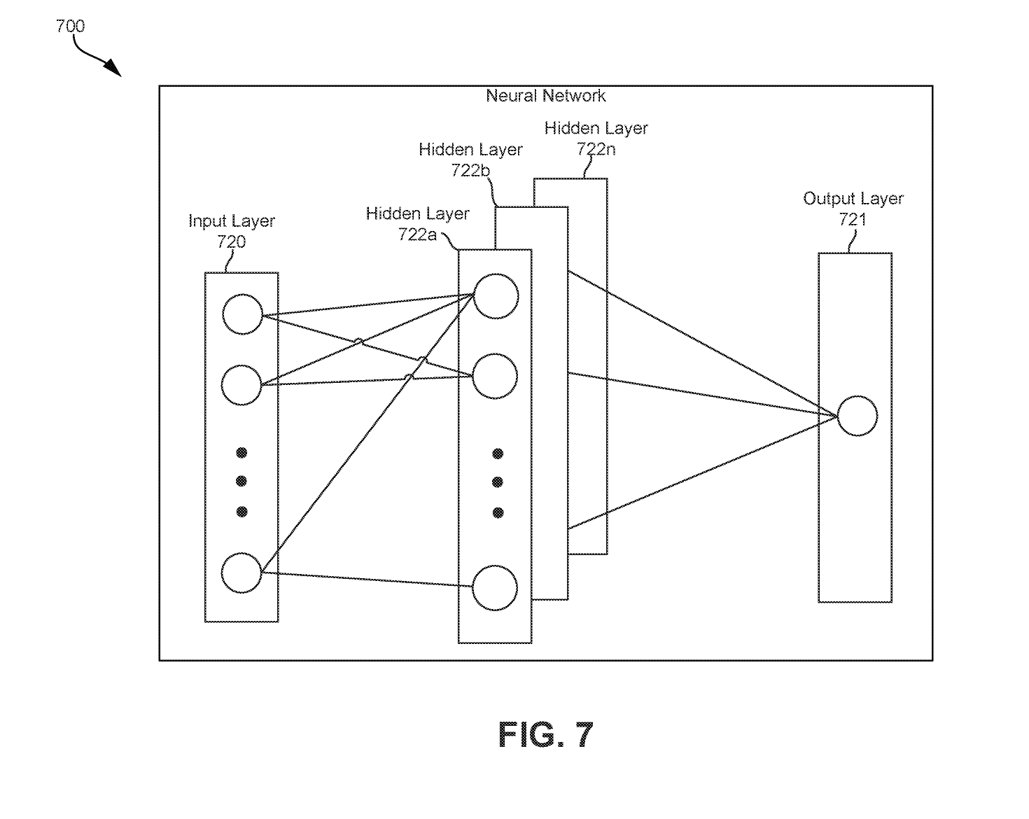

In some cases, software model 260 can include one or more software algorithms. For example, software model 260 can include one or more AI/ML models, such as LLM and implement a single AI/ML or multiple AI/ML models. In some examples, software model 260 can implement one or more neural networks (e.g., deep learning neural network 700 as illustrated with respect to FIG. 7 below). Each of the one or more neural networks can include any neural network type/architecture such as, for example and without limitation, a transformer network, a convolutional neural network, an autoencoder network, a sequence-to-sequence network, a recurrent neural network, a long short-term memory network, a mixture-of-experts network, an encoder and/or decoder network (e.g., encoder-decoder network, encoder-only network, decoder-only network, etc.), and/or any other artificial and/or deep learning neural network.

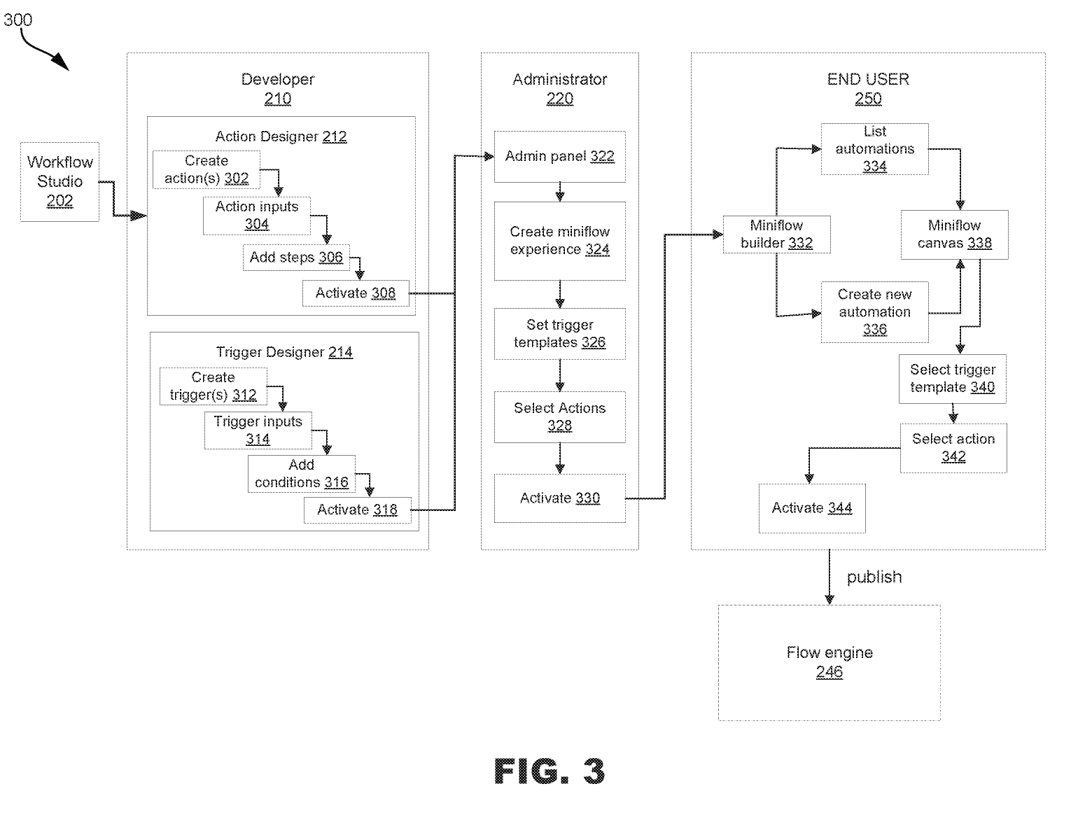

FIG. 3 illustrates a flowchart of an example system process 300 for providing an end user workflow automation framework in a production environment for end users, according to some examples of the present disclosure. Process 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Process 300 shall be described with reference to FIG. 2. However, method 300 is not limited to that example.

As previously described, an end-user workflow automation system of this present disclosure can include three roles/individuals (e.g., developer 210, admin 220, and end user 250) to create end-user automation. The workflow studio 202 includes various components (e.g., process(es) 222, flow(s) 224, subflow(s) 226, action(s) 228, decision(s) 230, etc.) that enable developer 210 and/or admin 220 to build and design an end-user workflow automation tool.

In some examples, by accessing workflow studio 202, action designer 212 can, based on input from developer 210, create and define action(s) for an end-user workflow automation tool, for example, for end user 250 to utilize (step 302). For example, action designer 212 may specify action(s) to be taken at each step of the workflow. At step 304, action designer 212 can further specify or define action inputs. The action inputs are parameters that end user 250 will provide for the action(s) to do its function. For example, for an action to “update an incident record assigned to value” the parameter value (e.g., action input) the action would receive is “assign to user” which is a reference to a sys_user record in the system. The action can use this value to dynamically update the record in the database. At step 306, action designer 212 may add a plurality of steps (e.g., a sequence of actions) available for end user 250 to select when creating workflow automation. At step 308, action designer 212 may finalize and activate the portion of the end-user workflow automation tool, which comprises inputs, steps (e.g., actions), and so on.

Further, trigger designer 214 may create and define trigger(s) at step 312. For example, the trigger(s) can define when to initiate the action(s), which include any task, function, operation, step, and/or process to implement for the flow. The trigger designer 214 may define one or more triggers that are available for end users to access in the end-user workflow automation tool. At step 314, trigger designer 214 may define trigger inputs. At step 316, trigger designer 214 can add a plurality of conditions (e.g., a trigger to start a flow). For example, trigger designer 214 may specify or customize various conditions such as an application, a role of end user 250, a state, a date, and any applicable criteria to be met. At step 318, trigger designer 214 may finalize and activate the portion of the end-user workflow automation tool, which comprises inputs, conditions (e.g., triggers), and so on.

In some examples, components of end-user workflow automation tool designed by developer 210 (e.g., action designer 212, trigger designer 214) can be provided to admin panel such that admin 220 can review and validate various components available for end user 250 at step 322. At step 324, based on input from administrator 220, a miniflow experience (e.g., an end-user workflow automation tool) comprising various components can be created. At step 326 and step 328, triggers and actions can be finalized respectively. For example, miniflow experience settings 232 associated with triggers and/or actions can be specified (e.g., accessibility, scope, a number of actions available for a specific flow, etc.). At step 330, the end-user workflow automation tool can be finalized and activated.

The end-user workflow automation tool that has been reviewed and validated by administrator 220 can be provided to miniflow builder (step 332), which provides an application or interface for end user 250 to build workflow automation in a production instance, utilizing the components designed by developer 210 and/or admin 220. In some examples, end user 250 can select and use a pre-built workflow template (e.g., from a list of automation) at step 334. Alternatively, a new automation can be created at step 336 based on input from end user 250. At step 338, end user 250 can, using miniflow canvas, design and specify details of the workflow within the production environment. At step 340 and step 343, triggers and actions can be defined based on input from end user 250 respectively. At step 344, the workflow built by end user 250 can be checked for any configuration errors and then be activated and published into flow engine 246.

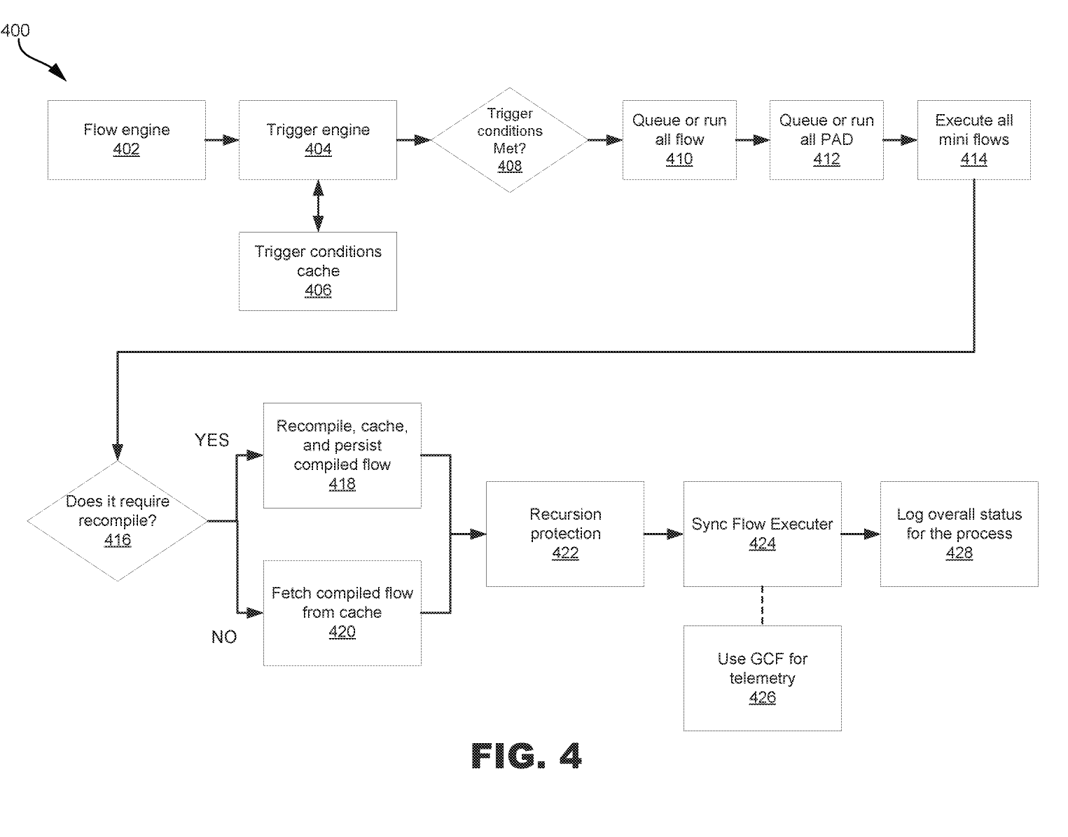

In some instances, flow engine 246 is configured to process the workflow automation. For example, flow engine 246 may execute a sequence of actions (e.g., steps) once one or more conditions (e.g., triggers) are met as indicated in the flow designed by end user 250. Further details relating to the flow engine are described below with respect to FIG. 4.

FIG. 4 illustrates a flowchart of an example process 400 of implementing an end user workflow automation engine, according to some examples of the present disclosure. Process 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Process 400 shall be described with reference to FIG. 2. However, process 400 is not limited to that example.

The implementation process 400 describes how the flow engine 402 works after it is implemented/designed by the user. As previously described, flow engine 402 (similar to engine 246 as illustrated with respect to FIGS. 2 and 3) is configured to execute workflow(s). In this example, workflow automation platform 110 can identify, for example, via trigger engine 404. In some examples, trigger conditions can be cached (step 406). At step 408, workflow automation platform 110 determines whether a trigger condition(s) has been met. If the flow trigger conditions are met, the flow can run a sequence of reusable actions and/or flow logic to complete the process. For example, workflow automation platform 110 may either queue for later execution or run the flow at step 410. At step 412, workflow automation platform 110 may either queue or run process automations. Further, at step 414, workflow automation platform 110 may execute all miniflows that were built.

In some examples, workflow automation platform 110 determines whether flow(s) need recompiling at step 416. If workflow automation platform 110 determines that recompile is required, it can recompile, cache, and persist compiled flow at step 418. Alternatively, at step 420, if workflow automation platform 110 determines that recompile is not required, it can fetch compiled flow from cache. As step 422, workflow automation platform 110 may provide recursion protection to avoid having the flow running recursively. Further, at step 424, workflow automation platform 110 may synchronously execute the flow (e.g., waiting until completed before continuing), for example, using Generic Collection Framework (GCF) for telemetry at step 426. At step 428, workflow automation platform 110 can log overall status for the process of the flow.

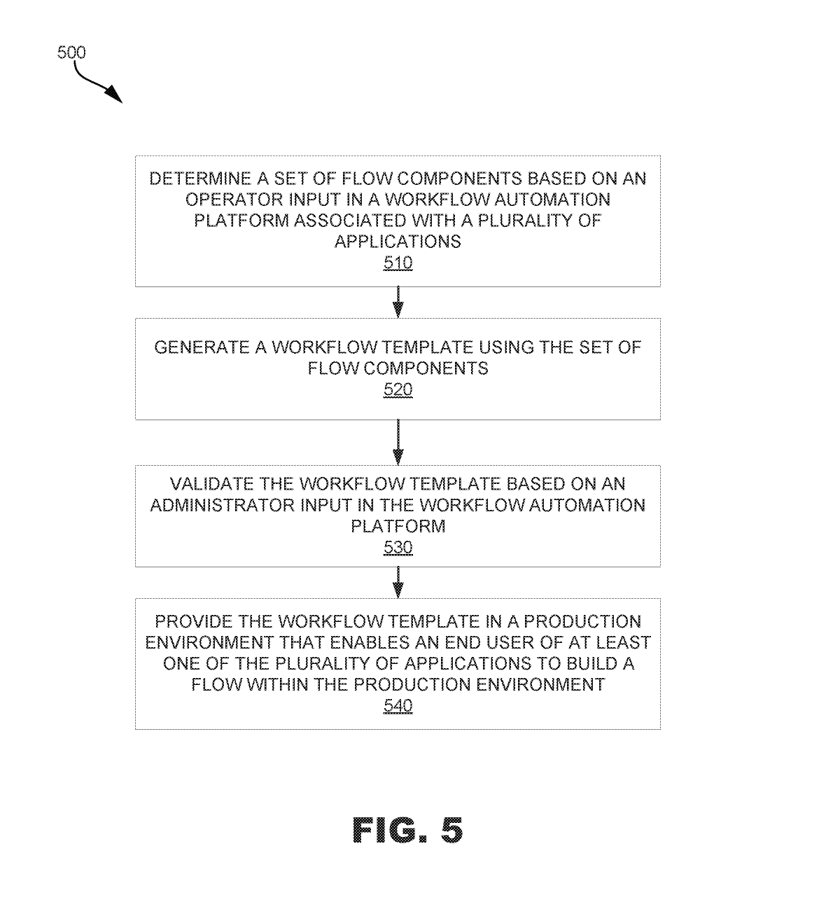

FIG. 5 is a diagram illustrating an example method 500 of providing an end user workflow automation framework, according to some examples of the present disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 500 shall be described with reference to FIG. 2. However, method 500 is not limited to that example.

At step 510, method 500 includes determining a set of flow components based on an operator input in a workflow automation platform associated with a plurality of applications. The set of flow components may include one or more actions and triggers. For example, end-user workflow automation system can determine, based on input from an operator (e.g., developer 210), a set of flow components such as actions, triggers, steps, conditions, and so on. As previously illustrated, platform 240 (similar to workflow automation platform 110 as illustrated in FIG. 1) may be associated with various host applications 254 such that the platform 240 can be accessed by different business units and individuals.

At step 520, method 500 includes generating a workflow automation tool using the set of flow components. For example, action designer 212 and/or trigger designer 214 may define and specify the set of flow components in a sub-production environment and generate a workflow automation tool, which enables end user 250 to create workflow automation in a production instance.

At step 530, method 500 includes validating the workflow automation tool based on an administrator input in the workflow automation platform. Also, validating the workflow automation tool can include determining configurations of the workflow automation tool. For example, various settings associated with the workflow automation tool can be configured and defined based on input from admin 220. Non-limiting examples of miniflow experience settings 232 can include a scope, accessibility, accessibility, a length of time for running the action, a number of actions that can be added, or a combination thereof.

At step 540, method 500 includes providing the workflow automation tool in a production environment. For example, upon validation from admin 220, the end-user workflow automation tool can be surfaced to a production environment for end user 250 to utilize in creating workflow automation. Having the end-user workflow automation tool available to end users in a production environment provides numerous technical benefits. Specifically, it can bridge the gap between developers, administrators, and end users since end users can connect pieces that are pre-built or validated by developers and administrators to create their own workflow without having to entirely rely on developers and administrators. The end users no longer need to wait until the developers and administrators to build the workflow, promote it, test it, and bring it to production. Further, end users can automate processes in a self-proficient manner, which can improve the personal productivity and efficiency and accuracy of the workflow automation.

Furthermore, the workflow automation tool enables an end user of at least one of the plurality of applications (e.g., host applications 254) to build a flow within the production environment. For example, the same workflow automation tool can be utilized by various business units. A single platform where all applications are interconnected can provide technical benefits by enabling the system to scale. The end-user workflow automation tool can create highly configurable miniflow experiences around various applications and business units to manage and automate their work such that user do not need to acquire alternative local production workflow tools.

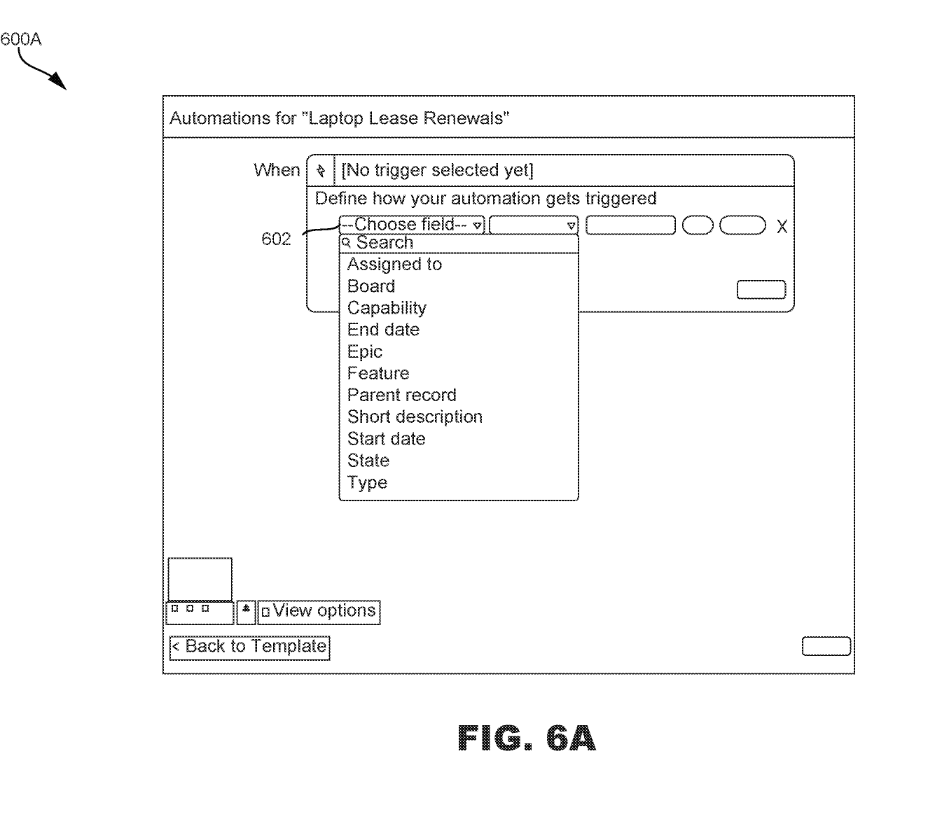

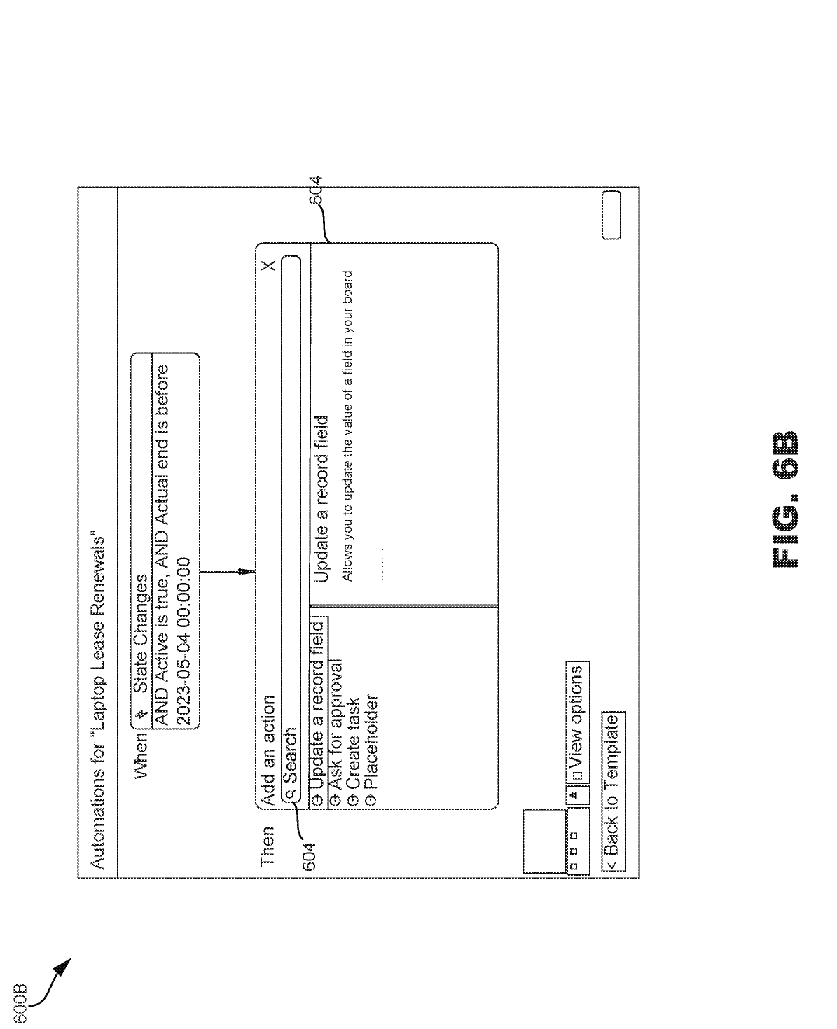

FIGS. 6A and 6B are diagrams 600A, 600B illustrating a user interface depicting an end-user workflow automation tool, according to some examples of the present disclosure. As shown in FIGS. 6A and 6B, an end-user workflow automation tool of the present disclosure enables end user 250 to create a workflow for automation in production instance. FIG. 6A illustrates an example interface 600A depicting a representation of a trigger selection. In this example, end user 250 is utilizing the end-user workflow automation tool to automate “laptop lease renewals.” As shown, the user interface 600A enables end user 250 to define one or more triggers from a selection window 602 providing a plurality of available elements. For example, end user 250 may search and/or select element(s) of the trigger(s) in situ (e.g., state changes, state changes to new, etc.).

FIG. 6B illustrates an example interface 600B depicting a representation of an action selection. As shown, the user interface 600B enables end user 250 to define one or more actions from a selection window 604 providing a plurality of available elements (e.g., update a record field, ask for approval, create task, placeholder, etc.). Further, the user interface 600B includes a panel 606 that provides information or explains the details of each of the available actions to help end user 250 better understand and select the action element.

The disclosure now turns to a further discussion of example software models and devices that can be used to implement the technologies described herein.

FIG. 7 is a diagram illustrating an example of a deep learning neural network 700 that can be used to implement all or a portion of the systems and techniques described herein, according to some examples of the present disclosure. For example, the neural network 700 can be used to implement software model(s) 260, and/or any other model(s) described herein (and/or component thereof).

An input layer 720 can be configured to receive data such as data included in an input prompt(s), input from developer 210, admin 220, and/or end user 250, and/or any other data described herein. Neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. Neural network 700 further includes an output layer 721 that provides an output resulting from the processing performed by the hidden layers 722a, 722b, through 722n.

Neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total = ∑(1/2 (target-output)^2). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as a transformer, autoencoder, Deep Belief Net (DBN), Recurrent Neural Network (RNN), an encoder and/or decoder network, among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

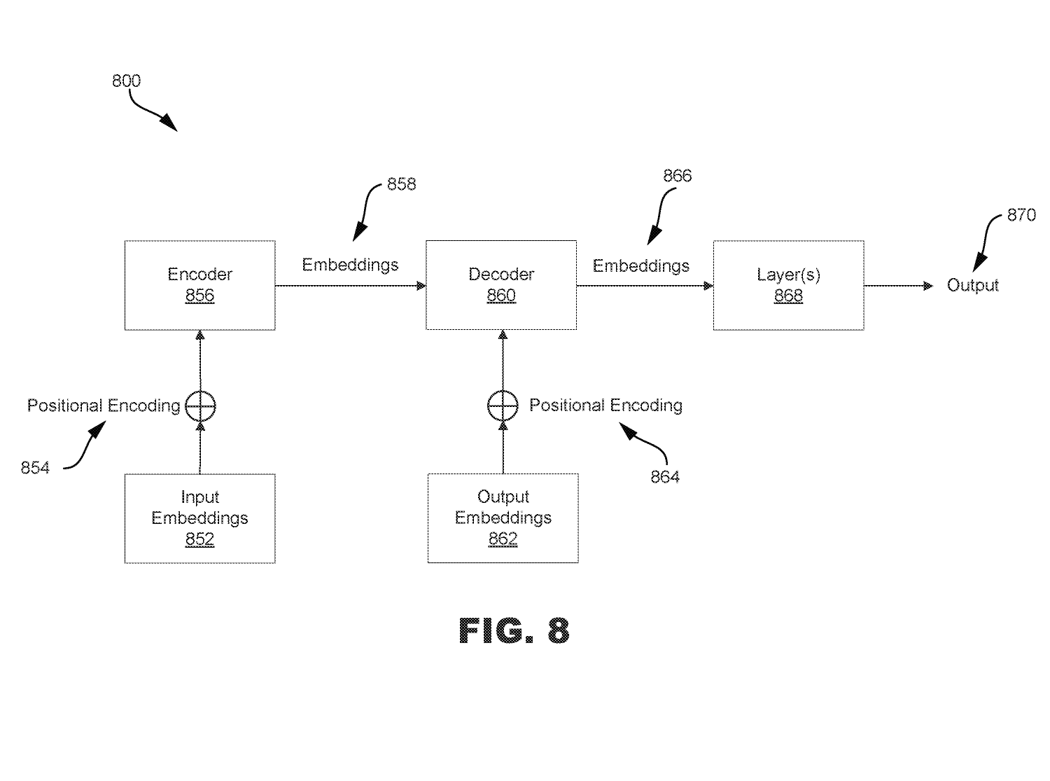

FIG. 8 is a diagram illustrating an example architecture of an example transformer model 800, according to some examples of the present disclosure. The transformer model 800 can be used to implement an LLM that can be used to implement the technologies described herein. For example, the transformer model 800 can be used to implement the software model(s) 260, and/or any other software model(s) described herein (and/or component thereof).

As shown, the transformer model 800 can include input embeddings 852 used as inputs to the transformer model 800. The input embeddings 852 can include input values representing words and/or sentences, such as numbers or vectors representing words and/or sentences.

In some cases, the input embeddings 852 can function like a dictionary that helps the transformer model 800 understand the meaning of words by placing them in an embedding space where similar words are located near each other. In some examples, the input interface 134 can be trained and/or configured to create the input embeddings 852 so that similar vectors represent words with similar meanings. In some examples, the transformer model 800 can additionally or alternatively learn to create and/or process the input embeddings 852 during training.

The transformer model 800 can use positional encoding 854 to encode the position of each word in an input sequence from the input embeddings 852 as values such as a set of numbers, a vector, etc. The values generated by the positional encoding 854 can be fed into the transformer model 800 along with the input embeddings 852. By incorporating the positional encoding 854 into the transformer model 800, the transformer model 800 can more effectively understand the order of words in a sentence and generate grammatically correct and semantically meaningful output.

The transformer model 800 can include an encoder(s) 856 used to process the positionally encoded input embeddings 852 and generate embeddings 858. The encoder(s) 856 can be part of the transformer model 800 that processes input text and generates hidden states that capture the meaning and context of the text. For example, the encoder(s) 856 can include a feed-forward neural network that is part of the transformer model 800. In some examples, the encoder(s) 856 can implement multiple encoder layers. In some cases, the encoder(s) 856 can first tokenize the input text into a sequence of tokens, such as individual words or subwords. The encoder(s) 856 can then apply one or more self-attention layers, which can generate hidden states that represent the input text at different levels of abstraction. In this way, the encoder(s) 856 can generate the embeddings 858 (e.g., a vector, a set of values, etc.) representing the semantics and position of words in one or more sentences.

The transformer model 800 can include output embeddings 862, which can include values representing words and/or sentences, such as numbers or vectors representing words and/or sentences. The output embeddings 862 can be similar to the input embeddings 852 and can also be processed by positional encoding 864 to encode the position of each word in a sequence from the output embeddings 862 as values such as a set of numbers, a vector, etc., which helps the transformer model 800 understand the order of words in a sentence. The output embeddings 862 can be used during a training phase of the transformer model 800 and can be used during an inference phase. During training, a loss function can be computed based on the output embeddings 862 and used to update the model parameters to improve the accuracy of the transformer model 800. During an inference phase, the output embeddings 862 can be used to generate the output text by mapping the predicted probabilities determined by the transformer model 800 for each token to the corresponding token in the vocabulary.

The positionally encoded input embeddings 852 (e.g., the embeddings 858) and the positionally encoded output embeddings 862 can be fed to a decoder(s) 860 used to generate the output sequence based on the encoded input sequence. During training, the decoder(s) 860 can learn how to guess the next word of a sequence by looking at the words before it. In some examples, the decoder(s) 860 can generate natural language text based on the input sequence and any learned context.

The decoder(s) 860 can generate embeddings 866 and feed the embeddings 866 to one or more network layers 868. In some examples, the one or more network layers 868 can include a linear layer and a softmax function. The linear layer can map the embeddings 866 generated by the decoder(s) 860 to a higher-dimensional space, which can transform the embeddings 866 into the original input space. The softmax function can then be applied to generate a probability distribution for each output token in the vocabulary, which can result in an output 870. In some examples, the output 870 can include output tokens with probabilities.

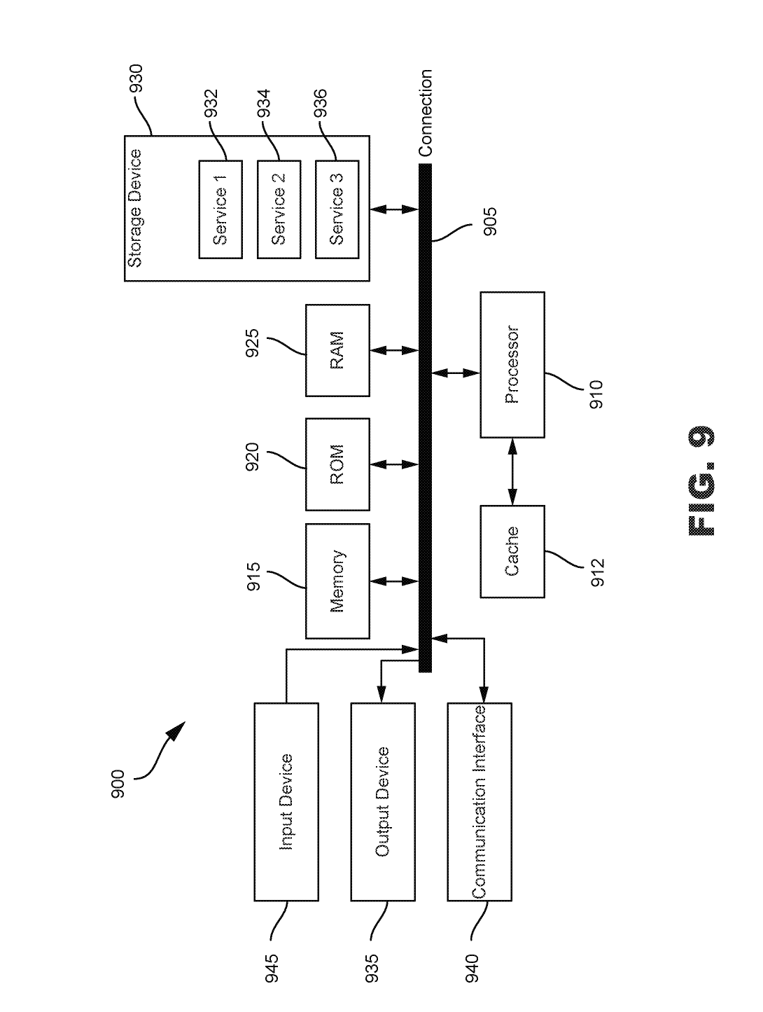

FIG. 9 illustrates an example processor-based system with which some aspects of the subject technology can be implemented. For example, processor-based system 900 can be any computing device making up the workflow automation platform 110, any of the client devices 116, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some implementations, one or more of the described system components represents many such components each performing some or all of the function for which the component is described. In some embodiments, the components can be physical or virtual devices.

Example system 900 includes at least one processing unit (Central Processing Unit (CPU) or processor) 910 and connection 905 that couples various system components including system memory 915, such as Read-Only Memory (ROM) 920 and Random-Access Memory (RAM) 925 to processor 910. Computing system 900 can include a cache of high-speed memory 912 connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communication interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 930 can include software services, servers, services, etc., that when the code that defines such software is executed by the processor 910, it causes the system 900 to perform a function. In some embodiments, a hardware service that performs a particular function can include the software component stored in a computer-readable medium in connection with the necessary hardware components, such as processor 910, connection 905, output device 935, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

### Illustrative examples of the present disclosure include:

Aspect 1. A computer-implemented method comprising: determining a set of flow components based on an operator input in a workflow automation platform, wherein the workflow automation platform is associated with a plurality of applications; generating a workflow automation tool using the set of flow components; validating the workflow automation tool based on an administrator input in the workflow automation platform; and providing the workflow automation tool in a production environment, wherein the workflow automation tool enables an end user of at least one of the plurality of applications to build a flow within the production environment.

Aspect 2. The computer-implemented method of Aspect 1, wherein the set of flow components comprises one or more actions and triggers.

Aspect 3. The computer-implemented method of any of Aspects 1 to 2, further comprising: receiving an end user input within the production environment, wherein the end user input includes a flow action and a flow trigger selected from the workflow automation tool; and generating the flow comprising executable instructions configured to trigger the flow action in response to a detection of the flow trigger.

Aspect 4. The computer-implemented method of Aspect 3, wherein the flow is generated using a large language model (LLM) based on the end user input.

Aspect 5. The computer-implemented method of any of Aspects 1 to 4, further comprising: determining accessibility of the workflow automation tool in the production environment.

Aspect 6. The computer-implemented method of any of Aspects 1 to 5, wherein validating the workflow automation tool based on the administrator input comprises: determining configurations of the workflow automation tool.

Aspect 7. The computer-implemented method of any of Aspects 1 to 6, further comprising: categorizing the workflow automation tool based on one or more characteristics of the workflow automation tool.

Aspect 8. A system comprising: one or more processors; and at least one computer-readable storage medium having stored therein instructions which, when executed by the one or more processors, cause the one or more processors to: determine a set of flow components based on an operator input in a workflow automation platform, wherein the workflow automation platform is associated with a plurality of applications; generate a workflow automation tool using the set of flow components; validate the workflow automation tool based on an administrator input in the workflow automation platform; and provide the workflow automation tool in a production environment, wherein the workflow automation tool enables an end user of at least one of the plurality of applications to build a flow within the production environment.

Aspect 9. The system of Aspect 8, wherein the set of flow components comprises one or more actions and triggers.

Aspect 10. The system of any of Aspects 8 to 9, wherein the instructions further cause the one or more processors to: receive an end user input within the production environment, wherein the end user input includes a flow action and a flow trigger selected from the workflow automation tool; and generate the flow comprising executable instructions configured to trigger the flow action in response to a detection of the flow trigger.

Aspect 11. The system of Aspect 10, wherein the flow is generated using a large language model (LLM) based on the end user input.

Aspect 12. The system of any of Aspects 8 to 11, wherein the instructions further cause the one or more processors to: determining accessibility of the workflow automation tool in the production environment.

Aspect 13. The system of any of Aspects 8 to 12, wherein validating the workflow automation tool based on the administrator input comprises: determining configurations of the workflow automation tool.

Aspect 14. The system of any of Aspects 8 to 13, wherein the instructions further cause the one or more processors to: categorize the workflow automation tool based on one or more characteristics of the workflow automation tool.

Aspect 15. A non-transitory computer-readable medium having instructions stored thereon that, when executed by one or more processors, cause the one or more processors to perform a method according to any of Aspects 1 to 7.

Aspect 21. A system comprising means for performing a method according to any of Aspects 1 to 7.

Aspect 22. A computer-program product having stored thereon instructions which, when executed by one or more processors, cause the one or more processors to perform a method according to any of Aspects 1 to 7.

What is claimed is:

1. A computer-implemented method comprising:
determining a set of flow components based on an operator input in a workflow automation platform, wherein the workflow automation platform is associated with a plurality of applications;
generating a workflow automation tool using the set of flow components;
validating the workflow automation tool based on an administrator input in the workflow automation platform; and
providing the workflow automation tool in a production environment, wherein the workflow automation tool enables an end user of at least one of the plurality of applications to build a flow within the production environment.

2. The computer-implemented method of claim 1, wherein the set of flow components comprises one or more actions and triggers.

3. The computer-implemented method of claim 1, further comprising:
receiving an end user input within the production environment, wherein the end user input includes a flow action and a flow trigger selected from the workflow automation tool; and
generating the flow comprising executable instructions configured to trigger the flow action in response to a detection of the flow trigger.

4. The computer-implemented method of claim 3, wherein the flow is generated using a large language model (LLM) based on the end user input.

5. The computer-implemented method of claim 1, further comprising:
determining accessibility of the workflow automation tool in the production environment.

6. The computer-implemented method of claim 1, wherein validating the workflow automation tool based on the administrator input comprises:
determining configurations of the workflow automation tool.

7. The computer-implemented method of claim 1, further comprising:
categorizing the workflow automation tool based on one or more characteristics of the workflow automation tool.

8. A system comprising:
one or more processors; and
at least one computer-readable storage medium having stored therein instructions which, when executed by the one or more processors, cause the one or more processors to:
determine a set of flow components based on an operator input in a workflow automation platform, wherein the workflow automation platform is associated with a plurality of applications;
generate a workflow automation tool using the set of flow components;
validate the workflow automation tool based on an administrator input in the workflow automation platform; and
provide the workflow automation tool in a production environment, wherein the workflow automation tool enables an end user of at least one of the plurality of applications to build a flow within the production environment.

9. The system of claim 8, wherein the set of flow components comprises one or more actions and triggers.

10. The system of claim 8, wherein the instructions further cause the one or more processors to:
receive an end user input within the production environment, wherein the end user input includes a flow action and a flow trigger selected from the workflow automation tool; and
generate the flow comprising executable instructions configured to trigger the flow action in response to a detection of the flow trigger.

11. The system of claim 10, wherein the flow is generated using a large language model (LLM) based on the end user input.

12. The system of claim 8, wherein the instructions further cause the one or more processors to:
determining accessibility of the workflow automation tool in the production environment.

13. The system of claim 8, wherein validating the workflow automation tool based on the administrator input comprises:
determining configurations of the workflow automation tool.

14. The system of claim 8, wherein the instructions further cause the one or more processors to:
categorize the workflow automation tool based on one or more characteristics of the workflow automation tool.

15. A non-transitory computer-readable medium having stored thereon instructions which, when executed by one or more processors, cause the one or more processors to:
determine a set of flow components based on an operator input in a workflow automation platform, wherein the workflow automation platform is associated with a plurality of applications;
generate a workflow automation tool using the set of flow components;
validate the workflow automation tool based on an administrator input in the workflow automation platform; and
provide the workflow automation tool in a production environment, wherein the workflow automation tool enables an end user of at least one of the plurality of applications to build a flow within the production environment.

16. The non-transitory computer-readable medium of claim 15, wherein the set of flow components comprises one or more actions and triggers.

17. The non-transitory computer-readable medium of claim 15, wherein the instructions further cause the one or more processors to:
receive an end user input within the production environment, wherein the end user input includes a flow action and a flow trigger selected from the workflow automation tool; and
generate the flow comprising executable instructions configured to trigger the flow action in response to a detection of the flow trigger.

18. The non-transitory computer-readable medium of claim 17, wherein the flow is generated using a large language model (LLM) based on the end user input.

19. The non-transitory computer-readable medium of claim 15, wherein the instructions further cause the one or more processors to:
determining accessibility of the workflow automation tool in the production environment.

20. The non-transitory computer-readable medium of claim 15, wherein validating the workflow automation tool based on the administrator input comprises:
determining configurations of the workflow automation tool.
